(19) United States
(12) Patent Application Publication
(10) Pub. No.: US 2023/0399161 A1
(43) Pub. Date: Dec. 14, 2023

(54) PACKAGE AND METHOD OF MANUFACTURING A PACKAGE

(71) Applicant: MULTIVAC MARKING & INSPECTION GMBH & CO. KG, Enger (DE)

(72) Inventors: Michael REFFKE, Roedinghausen (DE); Ronald HELMEL, Seeboden (AT); Tobias SCHROEDER, Enger (DE)

(73) Assignee: MULTIVAC MARKING & INSPECTION GMBH & CO. KG, Enger (DE)

(21) Appl. No.: 18/207,072

(22) Filed: Jun. 7, 2023

(30) Foreign Application Priority Data
Jun. 8, 2022 (DE) 102022114394.5

(51) Int. Cl. B65D 77/20; B65D 1/34; B65D 51/16; B65D 17/50; B65D 51/24; B65C 9/18; B65C 9/26

(52) U.S. Cl. CPC B65D 77/2024; B65D 1/34; B65D 51/1611; B65D 17/502; B65D 51/245; B65C 9/1869; B65C 9/26; B65D 2203/02; B65D 2205/02; B65D 2577/205

(57) ABSTRACT

The disclosure relates to a package having a package lower part for receiving a product and having a lid part attached to the package lower part for closing the package. The lid part includes a label and a carrier layer section, wherein the label adheres to the carrier layer section, and wherein the lid part is adhered to the package lower part by means of the label. Furthermore, the disclosure relates to a method of manufacturing a package.

### CROSS REFERENCE TO RELATED APPLICATIONS

This application claims foreign priority benefits under 35 U.S.C. § 119(a)-(d) to German patent application number DE 102022114394.5 filed Jun. 8, 2022, which is incorporated by reference in its entirety.

### TECHNICAL FIELD

The present disclosure relates to a package and to a method of manufacturing a package.

### BACKGROUND

EP 2 666 728 B1 discloses a thermoforming package machine having a labeler. The labeler is arranged downstream of a sealing station of the thermoforming package machine in the direction of production and is configured to provide each of the package troughs arriving from the sealing station and sealed therein with a top foil with a label. The respective labels are separated from a carrier layer and glued onto the lid part formed by the top foil.

Whereas in EP 2 666 728 B1 the top foil fed to the sealing station serves to seal the package troughs, the labels applied downstream of the sealing process by the labeler have the function of providing the sealed packages with an indication concerning the product contained therein, and therefore have an indicating function.

In view of the prior art described above, the disclosure is based on the object of providing a package that may be produced inexpensively and a process of manufacturing a package, which may be performed with reduced effort. Furthermore, the package should be producible in a sustainable manner.

### SUMMARY

The disclosure relates to a package having a package lower part for receiving a product, in particular for receiving a food product, for example fruit or vegetables. Furthermore, the package according to the disclosure includes a lid part that is attached to the package lower part for closing the package, wherein the lid part includes a label and a carrier layer section to which the label is adhered.

According to the disclosure, the lid part is adhered to the package lower part by means of the label. Thus, the label on the package according to the disclosure, in addition to its actual indication function, also functions to close the package. On the package according to the disclosure, the label is thus present not only as an information carrier, but also as a means used to fasten the lid part, and thus has a dual function.

The carrier layer section adhering to the label on its bottom side, enables product protection on the package according to the disclosure in order to prevent the product accommodated in the package lower part from coming into contact with the label, but is not itself adhered to the package lower part.

The package obtained according to the disclosure may be produced at low cost, since both the labeling process and the closing of the package are carried out thereon solely by adhering the lid part by means of the label, i.e., two processes are carried out by one operation. In addition, the label used as the lid part offers potential for improved recycling.

According to one variant, the carrier layer section is a blank from a carrier layer of a label roll used in the labeling process to provide several labels. Thus, from the label roll used for the labeling process, both the label and the carrier layer section are used to form the lid part for the package. Since even material from the carrier layer of the label roll is used for the lid part of the package, which in conventional applications forms scrap material, resulting in a package that conserves resources, i.e., may be produced sustainably.

Preferably, the carrier layer section is manufactured so as to be adapted to an opening formed by the package lower part for insertion of the product. In particular, the carrier layer section has a contour that is substantially identical to that of the package opening. On the package, the carrier layer section is thus effectively present as a product protection layer between the product accommodated in the package lower part and the label used as a lid, which is adhered to the package lower part. This enables preventing the product from coming into contact with an underside of the label, on which the label has an adhesive layer or is at least selectively provided with adhesive.

In one variant an adhesive layer is formed between the label and the carrier layer section. The adhesive layer may have an adhesive at least in places to secure the carrier layer section to the label. Optionally, the adhesive is applied between the carrier layer section and the label in a predetermined pattern. This may lead to a further cost reduction in the manufacture of the package.

It is conceivable that the carrier layer section is produced in the carrier layer by means of a die-cutting process or by means of a laser process as a cut belonging to the label and adhering to its underside. These separation processes enable the carrier layer section to be produced precisely to match the contour of the package opening.

In a preferred embodiment the label on the lid part forms a circumferential adhesive edge corresponding to a package edge formed on the package lower part. This adhesive edge thus projects beyond a surface of the carrier layer section for adhesion of the label to the package lower part. The adhesive edge is provided at least in places with an adhesive that is applied, for example, in accordance with the pattern of the adhesive layer.

Preferably, the package edge formed on the package lower part has a width of at least 4 millimeters. The label may be stably attached thereto, even in the event that adhesive is only applied in places between the package edge and the adhesive edge of the label.

It is an option for the package edge to be provided with a surface that is smooth for the label to adhere to. This surface may, for example, be made of a varnish or a plastic coating. This enables clean separation of the lid part from the package lower part.

For advantageous recyclability, it is conceivable for the package lower part to be a plastic tray and the label to be a plastic label, for the package lower part to be a cardboard tray and the label to be a paper label, or for the package lower part to be a cardboard tray and the label to be a plastic label. These packages may thus be manufactured essentially as mono-material packages, thereby forming sustainable packages as their recycling process is easier to perform.

According to one embodiment, the carrier layer section is made of a plastic foil. Such a carrier layer section forms a hygienic product protection, in particular irrespective of the material of which the label used to close the package lower part is made.

In particular, it may suffice for a desired product protection if the carrier layer section has a thickness of 30 μm≤x≤50 μm. In this way, the material input for the carrier layer section may be reduced enormously, so that package material costs may be minimized despite the product protection function that may thus be achieved.

Preferably, the lid part has at least one ventilation hole for the product received in the package. This provides air circulation for the package contents, which is particularly advantageous for packaged vegetables and fruit.

According to one variant, the lid part is transparent at least in certain areas. This means that the product contained in the package lower part may be viewed, which helps the consumer to select the product.

Preferably, the label contains at least one piece of information that may be read from it, in particular relating to the product contained in the package, for example its expiry date, and/or information relating to the manufacturing process of the package. It is possible that the label contains at least one piece of information printed thereon, for example information printed on the label by means of a thermal transfer printer, by means of an inkjet printer or by means of a thermal inkjet printer.

The package according to the disclosure may be used in particular for packaging fruit or vegetables. Ventilation holes formed on the lid part may ensure that the fruit or vegetable is exposed to sufficient air circulation within the package. The carrier layer section, which is present between the packaged product and the label, ensures that the product, for example fruit or vegetables, does not come into contact with an adhesive present on the underside of the label.

Furthermore, the disclosure relates to a method of manufacturing a package. The method according to the disclosure includes at least the following method steps:
providing a label roll including prefabricated labels and a carrier layer to which the labels are adhered, and
providing package lower parts filled with a product,
the method according to the disclosure being characterized in that
by separating the labels from the carrier layer, carrier layer sections adhering to the respective undersides of the labels are simultaneously separated from the carrier layer, wherein the respective labels together with the carrier layer sections from the carrier layer remaining adhered thereto form lid parts that are firmly adhered by means of the labels provided thereon to the package lower parts to form closed packages.

In contrast to conventional labeling processes, in which labels are separated from a carrier layer and glued alone, i.e., without parts of the carrier layer, to packages that have already been sealed, in the process according to the disclosure the respective labels are detached from the carrier layer together with the associated carrier layer sections, i.e., these are detached as a composite, and glued as “composite lid parts” to package lower parts that are provided but are still open, in order to form closed packages. This approach results in an increased potential for savings, since even carrier layer section from the carrier layer are used as product protection on the package produced according to the disclosure. It is of importance that material is used as product protection on package according to the disclosure that originates from the carrier layer of the label roll used for the labels, which conventionally forms scrap material. On the one hand, this ensures sustainable production of the package according to the disclosure and, on the other hand, it ensures reduced scrap material, since only a carrier layer grid remains as a waste product of the labeling process, without the carrier layer sections taken along from the carrier layer cut from the labels.

Conceivably, the label roll used for the method of manufacturing a package according to the disclosure is produced as follows:
providing a web of material with a label layer adhered to a carrier layer,
punching or laser cutting the label layer to define therein labels having a predetermined shape,
peeling off a punched grid formed by the punching or laser cutting of the label layer so that individual labels of the predetermined shape remain adhered to the carrier layer,
die-cutting or laser cutting the carrier layer to form carrier layer sections therein for the respective labels, and
winding the material web prefabricated by punching or lasering into a label roll.

Such a label roll may be used on a labeler for producing a package according to the disclosure.

### BRIEF DESCRIPTION OF THE DRAWINGS

Embodiments according to the disclosure are explained in more detail with reference to the following figures. In the figures:

FIG. 1 is a perspective view of a labeler for manufacturing a package according to the disclosure;

FIG. 2 is a perspective view of a package according to the disclosure;

FIG. 3 is a sectional view of the package shown in FIG. 2;

FIG. 4A shows labels glued to a carrier layer from above; and

FIG. 4B shows the carrier layer with labels from 4A from below.

Identical components are shown throughout the figures with the same reference signs.

### DETAILED DESCRIPTION

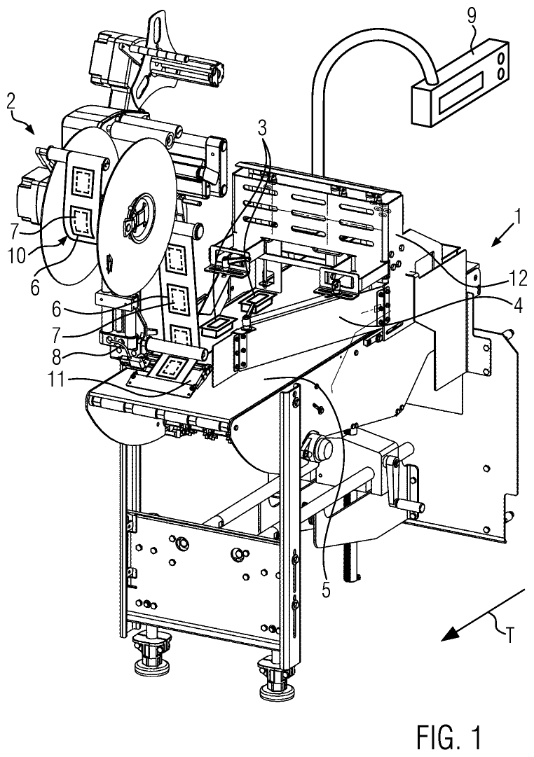

FIG. 1 shows a feeding device 1 and a labeler 2 arranged in a transport direction T at the end of the feeding device 1. In FIG. 1, the feeding device 1 is a line unifier. By means of the feeding device 1, package lower parts 3, which are not yet provided with a lid, are fed to the labeler 2. Two guide rails 4 are positioned so as to converge to each other in such a way that at the downstream end of the guide rails 4 a gap or opening is formed for the package lower parts 3, which is only slightly wider than the width of the package lower parts 3 themselves.

This enables the package lower parts 3 transported on the feed device 1 by means of a transport belt 5 running along it to be precisely fed to the labeler 2. This in turn allows for a label 6 with a carrier layer section 7 adhering to its underside to be precisely adhered in combination to a supplied package lower part 3 in order to seal the package lower part 3.

A sensor 8 provided on the labeler 2 is configured to detect a leading edge of a package lower part 3 to be labeled and sealed while the package lower part 3 is transported along the guide rails 4. The sensor 8 may be configured as a light barrier or proximity sensor and is connected to a controller 9 and transmits the signal to it, namely the detection of the leading edge of the package lower part 3. The controller 9 controls the movement of the label 6 to be dispensed, including the carrier layer section 7 adhering thereto, by means of the speed and path of a label roll 10 attached to the labeler 2 towards and along a dispensing edge 11, in order to detach the label 6 together with the carrier layer section 7 from the label roll 10 and apply it to the package lower part 3.

Preferably, the speed of the label roll 10 during the dispensing process onto the package lower part 3 is identical to the speed of the conveyor belt 5.

Upstream of the labeler 2, a stopper device 12 is arranged on the feeding device 1 in front of the guide rails 4 to stop package lower parts 3 while the conveyor belt 5 is running. Stopped package lower parts 3 may thus be released piece by piece for the labeling process at the labeler 2.

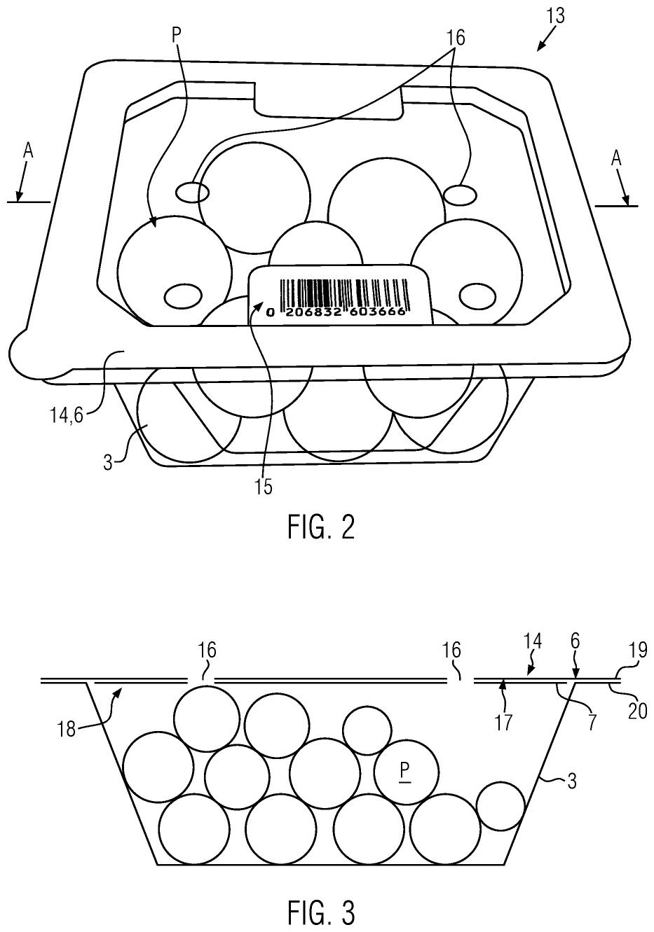

FIG. 2 shows a finished package 13. The package lower part 3 of the package 13 is filled with a product P, in this case tomatoes. The package 13 of FIG. 2 has a lid part 14 that is attached to the package lower part 3 for closing the package 13. The lid part 14 is formed by the label 6 and the carrier layer section 7 arranged thereunder, the lid part 14 being adhered to the package lower part 3 by the label 6 provided thereon.

Referring to FIG. 2, the label 6 has a plurality of visible information 15, for example a readable bar code. Further, the lid part 14 has ventilation holes 16 to provide air circulation.

FIG. 3 shows the package 13 of FIG. 2 in section A-A. In FIG. 3, it is shown that the carrier layer section 7 is attached to an underside 17 of the label 6. The label 6 may be provided on its underside 17 with an adhesive layer, by means of which the carrier layer section 7 is held to the label 6. According to FIG. 3, the carrier layer section 7 is present as a separating layer between the product P accommodated in the package lower part 3 and the label 6 inserted as a lid. The lid part 14 inserted on the package 13 thus has a label 6 that is used both for closing the package lower part 3 and also representing an information carrier.

FIG. 3 shows that the carrier layer section 7 is made so as to be adapted to an opening 18 formed by the package lower part 3 for insertion of the product P.

In FIG. 3, the label 6 is adhered by means of a circumferential adhesive edge 19 formed thereon to a package edge 20 correspondingly formed on the package lower part 3.

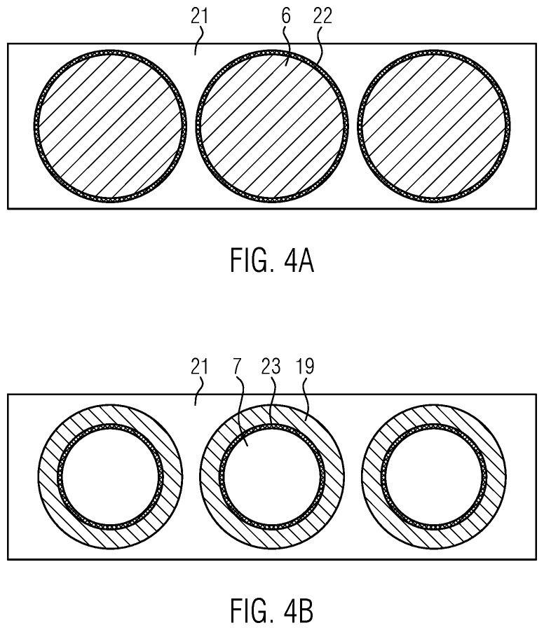

FIG. 4A shows a carrier layer 21 with individual labels 6 glued thereon. The labels 6 are made from a label layer (not shown) in accordance with the round label blanks 22 shown in FIG. 4A, for example laser-cut or punched.

FIG. 4B shows the carrier layer 21 of FIG. 4A from below. FIG. 4B shows in particular that carrier layer sections 7 are incorporated in the carrier layer 21, for example punched or laser-cut. The carrier layer sections 7 are present as round carrier layer section blanks 23. The carrier layer section blanks 23 are arranged concentrically to the larger label blanks 22 to form the adhesive edge 19 of the labels 6.

Thus, the labels 6 shown in FIG. 4A and FIG. 4B may be detached from the carrier layer 21 together with the associated carrier layer sections 7 to be used as lid parts 14 for closing package lower parts 3 by being adhered to the package edge 20 of the respective package lower parts 3 by means of the adhesive edge 19.

As those skilled in the art will understand, the controller 9, as well as any other controller, unit, component, module, system, subsystem, sensor (e.g., sensor 8), element, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, steps, functions and/or operations described herein, including interaction between and/or cooperation with each other. One or more of such processors, as well as other circuitry and/or hardware, may be included in a single Application-Specific Integrated Circuit (ASIC), or several processors and various circuitry and/or hardware may be distributed among several separate components, whether individually packaged or assembled into a System-on-a-Chip (SoC).

What is claimed is:

1. A package comprising a package lower part for receiving a product, and a lid part attached to the package lower part for closing the package, wherein the lid part comprises a label and a carrier layer section to which the label is adhered, wherein the lid part is adhered to the package lower part by means of the label.

2. The package according to claim 1, wherein the carrier layer section is manufactured so as to be adapted to an opening formed by the package lower part for inserting the product.

3. The package according to claim 1, wherein the label forms a peripheral adhesive edge on the lid part, which corresponds to a package edge formed on the package lower part.

4. The package according to claim 1, wherein the package lower part is a plastic tray and the label is a plastic label.

5. The package according to claim 1, wherein the package lower part is a cardboard tray and the label is a paper label.

6. The package according to claim 1, wherein the package lower part is a cardboard tray and the label is a plastic label.

7. The package according to claim 1, wherein the carrier layer section is made of a plastic foil.

8. The package according to claim 1, wherein the carrier layer section has a thickness x defined by 30μm≤x≤50 μm.

9. The package according to claim 1, wherein the lid part has at least one ventilation hole for the product received in the package.

10. The package according to claim 1, wherein the lid part is configured to be transparent at least in regions.

11. The package according to claim 1, wherein the product comprises a fruit or a vegetable.

12. A method of manufacturing a package, comprising:
providing a label roll comprising prefabricated labels and a carrier layer, the labels adhering to the carrier layer; and
providing package lower parts that are each loaded with a product;
separating the labels from the carrier layer so that carrier layer sections adhering to respective undersides of the labels are simultaneously separated from the carrier layer, wherein the respective labels together with the carrier layer sections remaining adhered thereto from the carrier layer form lid parts; and
adhering the lid parts to the package lower parts by means of the labels provided thereon to form closed packages.

13. A method of manufacturing packages, the method comprising:
separating prefabricated labels from a carrier layer to which the labels are adhered so that carrier layer sections adhering to respective undersides of the labels are simultaneously separated from the carrier layer, wherein the respective labels together with the carrier layer sections remaining adhered thereto from the carrier layer form lid parts; and
adhering the lid parts to package lower parts, which are each loaded with a product, by the labels of the lid parts to form closed packages.
